(19) United States
(12) Patent Application Publication
(10) Pub. No.: US 2005/0021398 A1
(43) Pub. Date: Jan. 27, 2005

(54) Method and system for downloading digital content over a network

(75) Inventors: Scott McCleskey, American Fork, UT (US); Robert O'Kane, Boynton Beach, FL (US)

Correspondence Address: Lloyd W. Sadler;Parsons Behle & Latimer, Suite 1800, 201 South Main Street, Salt Lake City, UT, 84111, US

(73) Assignee: WebHound Corporation

(21) Appl. No.: 10/672,644

(22) Filed: Sep. 27, 2003

Related U.S. Application Data
(63) Continuation-in-part of application No. 09/683,228, filed on Dec. 4, 2001.
Application No. 09/683,228 is a continuation-in-part of application No. 10/002,267, filed on Nov. 21, 2001.

(51) Int. Cl. G06F 17/60; G06F 15/16

(52) U.S. Cl. 705/14; 709/217

(57) ABSTRACT

A system and method for managing the acquisition of desired digital data files by a user over a network where royalty fees can be collected from advertisers for the payment of royalties to the owners of the desired digital data files. This invention facilitates the transfer and legalization of such data files as audio files, video files, graphics files, text files and multimedia files in an efficient commercial manner which provides and uses marketing information in the selection of appropriate advertisements.

### CROSS REFERENCE TO RELATED APPLICATIONS

This application is a Continuation-in-Part application of prior co-pending and co-owned U.S. patent application Ser. No. 09/683,228 filed on Dec. 4, 2001 and Ser. No. 10/002,267 filed on Nov. 21, 2001, which in turn claimed priority to Provisional Patent Application No. 80/252,334, filed on Nov. 23, 2000.

### BACKGROUND OF INVENTION

1. Field of the Invention

This invention relates to methods and systems for downloading data across a computer network. More specifically, this invention relates to methods and systems for downloading digital data, from a computer network, wherein the download and/or access to the downloaded data can be controlled.

2. Description of Related Art

A wide variety of techniques have been proposed for managing the access and control of digital data over a computer network. Generally these prior techniques fail to adequately the address the problem of unauthorized copies of digital data and fail to provide a mechanism for collecting fees for the downloading of such digital data.

Typical conventional systems for sharing information and or files over a computer network require that an originator of the information provide the information through an electronic site such as an electronic bulletin board or web site. Users wishing to obtain the information must use specific software on their computers, which allow them to access, use, store, play or display the information. Examples of the information of interest include text, graphical images, sound files, combinations of the foregoing and the like. Once the information is obtained by a user, the originator has little, if any, ability to control what the user does with the information. For example, the user may subsequently, in violation of the of the wishes of the originator, copy or disseminate the information to third parties. The originator is therefore unable to control whom and when the information can be used, listened to, read, or seen. The originator is unable to track transfers or to enforce the payment of desired royalties.

Networking technologies, such as Peer-to-Peer (P2P) or file sharing networks, can allow an individual computer user to open their computer related hard disk drives directly to other networked computer users, thereby searching and swapping files without recourse to traditional web databases and/or servers. Again, generally there is no method or process for determining and tracking file transfers or for enforcing the collection of royalties for “proper use.” In recent years, companies that manage these types of networks, P2P networking, or file sharing networks, allowed people to share music files, video files and nearly every other file with no regulatory control. P2P networks, by definition, do not have controls or processes that help those how own multi-media intellectual property rights to track, sell and determine who shares and uses digital media files (video, audio, art, text and the like) and this loss of control and security has made it more difficult for entrepreneurs and businesses to devise business models that curb copyright infringement and address security fears.

P2P audio and video networks typically work as follows: (1) a user/computer user asks a “computer or network related computer or server” if an audioart file exists on that particular computer or network related computer or server; (2) every computer or network server or “hooked-up” device on the network responds with a Yes or a No; (3) every computer or network server or “hooked-up” device that answered Yes, then hooks up or hooks directly into the user/computer's computer or network related computer or server for download, or alternatively, the user receives the file in or through an email message, or alternatively, the user transfers the file on a portable memory card (as used with portable MP3 players), or alternatively, the user uses a wireless enabled device (such as a cellular telephone, personal data assistant (PDA), or the like), or alternatively the user shares/copies/uploads/modifies the file using an electronic communication device or devices.

Esther Dyson, chairwoman of the Internet Corporation for Assigned Names and Numbers, wrote in an October 2000 column, “Peer-to-peer communities need a way to define and identify their members. They need a way to define their own rules and to exclude people who break them.” Business interests are already trying to find answers that will allow for widespread legal P2P commercialization. As an example of how P2P networks continue to lack access control, NAPSTER, KaZaA, Aimster, BearShare, Gnutella and others have been brought into a variety of lawsuits. The industry has yet to develop a way to track the exchange and/or download and illegal use of intellectual property (i.e., music, video, software and the like). The former NAPSTER (www.napster.com) and currently KaZaA, Morphius and others provide illuminated illustrations of P2P or file sharing business models and infrastructure. Record companies are finding that their music is being subject to unauthorized distribution at unprecedented speeds.

Any enterprise that hopes to commercialize digital content must find a way to stop losing potential business and related revenues and must find a way to control the access, distribution and use of the content without giving away the profitable “commercialization” possibilities.

A substantial amount of evidence exists that shows that people use P2P type networks and “shared file” networks only because they do not have to pay for all of the material they download. Naturally, entities that own respective files, that are “shared” cannot effectively take millions of individual users to court. They will, however, attempt to shut down the entities that supply a way for the files to be exchanged for free.

Business and corporate leaders are trying to develop methods to keep all parties involved within the P2P platform chain satisfied, legal and working. Some of these methods include “paid” subscription business models. The most successful methods, however, continue to be the P2P networks that offer little regulation or protection of rightful properties inside their anonymous networks—the networks themselves being effective barriers to creating mainstream, integrated business processes.

Although the following may not necessarily be “prior art,” the reader is referred to the following U.S. patent documents for general background material. Each of these patent documents is hereby incorporated by reference in its entirety for the material contained therein.

U.S. Pat. No. 5,745,569 describes a method for protecting computer code copyrights by encoding the code into a data resource with a digital watermark.

U.S. Pat. No. 5,805,804 describes a system and method for providing multimedia data in a networked system.

U.S. Pat. No. 5,809,242 describes a system for providing scheduled messages to a remote user in a batch-oriented system.

U.S. Pat. No. 5,850,218 describes a system and method for providing a full service cable television system.

U.S. Pat. No. 5,889,868 describes implementations of digital watermarks that are suited to a particular transmission, distributions and storage.

U.S. Pat. Nos. 5,892,900, 5,910,987, 5,915,019, 5,917,912, 5,949,876 and 5,982,891 describe systems and methods for electronic commerce that includes secure transaction management and electronic rights protection.

U.S. Pat. No. 5,898,777 describes a digital product dissemination and sale method.

U.S. Pat. No. 5,920,861 describes a descriptive data structure that provides an abstract representation of a rights management data structure such as a secure container.

U.S. Pat. No. 6,014,502 describes a system for providing scheduled messages to a remote user in a batch-oriented system.

U.S. Pat. No. 6,029,200 describes a streaming multimedia rendering system having a network client and a network server that form part of a hyperlink web such as the Internet. In accordance with the invention, a hyperlink to multimedia content is actually an indirect link to a reference file, which contains a plurality of different resource specifiers and a preferred order for attempting communications using the resource specifiers.

U.S. Pat. No. 6,058,106 describes network protocol method, access point device and peripheral devices that provide a centrally coordinated peer-to-peer wireless communications network.

U.S. Pat. No. 6,069,647 describes a system featuring an interface unit that is connected to a programmable unit.

U.S. Pat. No. 6,073,124 describes a method and system for facilitating digital commerce using a secure digital commerce system.

U.S. Pat. No. 6,088,337 describes a method, access point device and a plurality of peripheral devices for controlling a space diversity switch in a time division duplex system.

U.S. Pat. No. 6,101,180 describes a method of multicasting digital data to a user accessing an Internet connection.

U.S. Pat. No. 6,112,181 describes systems and methods for rights management of information that is used at least in part in a matching, narrow casting, classifying and/or selecting process.

U.S. Pat. No. 6,135,646 describes methods of managing digital objects in a network.

U.S. Pat. No. 6,137,710 describes a connecting apparatus, which can be used in combination with a plurality of IC cards.

U.S. Pat. No. 6,138,119 describes a descriptive data structure that provides an abstract representation of a rights management data structure such as a secure container.

U.S. Pat. No. 6,170,0174 B1 describes methods, devices and system that are provided in a multi-level computer architecture for providing improved capabilities for managing courseware and other content in a shared use-operating environment such as a computer network.

U.S. Pat. No. 6,189,008 B1 describes a method and apparatus used in a system for distributing digital contents from a central server to a plurality of endpoint servers.

U.S. Pat. No. 6,183,097 B1 describes a digital certificate that includes framing characters defining a protected area.

U.S. Pat. No. 6,183,366 B1 describes an information service and advertising providing system for presenting interactive information services together with interactive advertising on a communications networks such as the Internet and LANs.

U.S. Pat. No. 6,199,106 B1 describes a system for providing scheduled messages to a remote user in a batch-oriented system.

U.S. Pat. No. 6,200,216 B1 describes a system for the application of a trading card metaphor to a disassociated computer program.

U.S. Pat. No. 6,223,291 B1 describes a wireless electronic commerce system that comprises a wireless gateway to a wireless network.

U.S. Pat. No. 6,226,618 B1 describes a method and apparatus of securely providing data to a user's system.

U.S. Pat. No. 6,237,786 B1 and U.S. Pat. No. 6,253,193 B1 describe systems and methods for secure transaction management and electronic rights protection.

U.S. Pat. No. 6,248,946 B1 describes a system and method for delivering multimedia content to computers over a computer network, such as the Internet, and includes a novel media player, which may be downloaded onto a user's personal computer.

U.S. Pat. No. 6,256,664 B1 describes a method and apparatus for computed relevance messaging.

U.S. Pat. No. 6,262,982 B1 describes a method of multicasting digital data to a user accessing an Internet connection.

U.S. Pat. No. 6,263,313 B1 describes a method of automatically selecting processing parameters for encoding digital content.

U.S. Pat. No. 6,263,362 B1 describes an inspector for computed relevance messaging.

U.S. Pat. No. 6,282,573 B1 describes methods, devices and systems in a multi-level computer architecture, which provides capabilities for managing courseware and other content in a shared use-operating environment such as a computer network.

U.S. Pat. No. 6,285,776 B1 describes methods for identifying equipment used in counterfeiting.

U.S. Pat. No. 6,292,188 B1 describes a system and method for an interactive navigation system for exploring or browsing digital content data.

U.S. Pat. No. 6,311,211 B1 describes a method of operating an advocacy network.

U.S. Pat. No. 6,327,652 B1 describes the loading and identifying in a digital rights management operating system.

U.S. Pat. No. 6,330,670 B1 describes a digital rights management operating system.

U.S. Pat. No. 6,331,865 B1 describes a method and system for electronically distributing digital contents.

U.S. Pat. No. 6,343,319 B1 describes a method and system for curriculum delivery.

U.S. Pat. No. 6,345,104 B1 describes digital watermarks and methods for security documents.

U.S. Pat. No. 6,345,256 B1 describes a method to automatically retrieve data associated with content.

U.S. Pat. No. 6,356,936 B1 describes a relevance clause for computed relevance messaging.

U.S. Pat. No. 6,363,149 B1 describes a method for deriving past keys by using a one way function to relate an ordered sequence of keys to each other.

U.S. Pat. No. 6,363,357 B1 describes a method for selling a digital content product in an online commercial transaction.

U.S. Pat. No. 6,363,418 B1 describes a method for on-line controlling of caching of an image on a viewing device.

U.S. Pat. No. 6,363,488 B1 and U.S. Pat. No. 6,389,402 B1 describe systems and methods for secure transaction management and electronic rights protection.

U.S. Pat. No. 6,366,914 B1 describes a digital department system.

U.S. Pat. No. 6,389,337 B1 describes an in-vehicle device data that communicates with Internet based data processing resources for transacting e-mail, e-commerce, and e-business.

U.S. Pat. No. 6,389,403 B1 describes a system for tracking usage of digital content on user devices.

U.S. Pat. No. 6,389,537 B1 describes a cryptographic device that comprises a processing logic and memory associated with the processing logic.

U.S. Pat. No. 6,389,538 B1 describes a system for tracking usage of digital content on user devices.

U.S. Pat. No. 6,389,541 B1 describes regulating access to digital content.

U.S. Pat. No. 6,396,503 B1 describes a server that stores a first multi-resolution texture pyramid and a 3-D geometry object.

U.S. Pat. No. 6,398,245 B1 describes a method of managing keys used by a digital content player on a computer system.

U.S. Pat. No. 6,400,996 B1 describes an adaptive interface for a programmable system, for predicting a desired user function.

U.S. Pat. No. 6,405,203 B1 describes a system, method and article of manufacture for tracking the distribution of content electronically.

U.S. Pat. No. 6,418,421 B1 describes a system for tracking usage of digital content on user devices.

U.S. Pat. No. 6,427,020 B1 describes methods and devices for recognizing banknotes and responding accordingly.

U.S. Pat. No. 6,427,140 B1 describes systems and methods for secure transaction management and electronic rights protection.

U.S. Pat. No. 6,430,301 B1 describes a system for embedding and detecting digital watermarks.

U.S. Pat. No. 6,434,535 B1 describes a system and method for distribution of electronic content over a network.

U.S. Pat. No. 6,446,004 B1 describes a system and associated method that allows particular requests to be executed at some point in the future.

U.S. Pat. No. 6,449,377 B1 describes methods and systems for watermark processing of line art images.

U.S. Pat. No. 6,453,420 B1 describes a system, method and article of manufacture for tracking the distribution of content electronically.

U.S. Pat. No. 6,456,725 B1 describes a method for utilizing a title signal contained in digital data through a comparison of the title signal to a player signal stored in a player device.

U.S. Pat. No. 6,457,640 B2 describes an automated teller machine that includes an input device, a card reader, a cash dispenser and an output device.

U.S. Pat. No. 6,460,163 B1 describes an e-commerce method for selling digital content over the Internet with an FTP-like protocol provided to carry out the delivery (download) of a purchased digital content item from a server computer to a client computer operated by the purchaser.

U.S. Pat. No. 6,463,534 B1 describes a method of conducting transactions in a wireless electronic commerce system.

U.S. Pat. No. 6,490,587 B2 describes a method and apparatus for distributing digital contents from a central server to a plurality of endpoint servers for further distribution to end users for automatically managing the digital assets of the endpoint servers.

U.S. Pat. No. 6,507,727 B1 describes a system that facilitates the purchase and delivery of audio and video content (e.g., entertainment media) over the Internet.

U.S. Pat. No. 6,516,341 B2 describes a system for providing scheduled messages to a remote user in a batch-oriented system.

U.S. Pat. No. 6,522,767 B1 describes an implementation of digital watermarks that can be optimally suited to particular transmission, distribution and storage mediums given the nature of digitally sampled audio, video and other multimedia works.

U.S. Pat. No. 6,522,771 B2 describes the encoding of security documents to convey machine-readable multi-bit binary information (e.g., digital watermark), usually in a manner not alerting human viewers that such information is present.

U.S. Pat. No. 6,529,949 B1 describes a system, method and article of manufacture provided for remotely controlling content stored on a local computer connected to a network system such as the Internet.

U.S. Patent Application US 2001/0010046 A1 describes a method for distribution to and management of an inventory of digital content in a digital content vending machine.

U.S. Patent Application US 2001/0037304 A1 describes a method and apparatus for the delivery of proprietary audio and visual works to purchaser electronic devices.

U.S. Patent Application US 2001/0037367 A1 describes a system and method for information sharing via a virtual shared area in a communication network.

U.S. Patent Application US 2001/0042016 A1 describes a local portal system that includes a personal computerized system having a display and a primary storage unit.

U.S. Patent Application US 2001/0056405 A1 describes a method for collecting user data and constructing a user profile as a digital content vending machine.

U.S. Patent Application US 2002/0002468 A1 describes a method and system for forming a data table in memory on an end user system.

U.S. Patent Application US 2002/0002488 A1 describes a method for providing offline advertising.

U.S. Patent Application US 2002/0004744 A1 describes a system for targeting and delivering digital content to a user on a personal computerized system having a primary storage unit and a communications link.

U.S. Patent Application US 2002/0016776 A1 describes a method and apparatus for distributing digital content that includes a local storage medium, a local digital content reader, a remote digital content enabler, and a transmission medium.

U.S. Patent Application US 2002/0051540 A1 describes a method and apparatus for controlling access to digital information utilizes a location identity attribute that defines a specific geographic location.

U.S. Patent Application US 2002/0091575 A1 describes a system, method and apparatus for tracking usage of a recording medium based on an identifier stored on the recording medium.

U.S. Patent Application US 2002/0107803 A1 describes a method, system and computer readable medium for the blocking of recording digital content at an end user multimedia end-user-system during the rendering of encrypted digital multimedia files.

U.S. Patent Application US 2002/0146122 A1 describes a method and system for secure distribution of digital media files that includes text, video, audio and combinations of these.

U.S. Patent Application US 2003/0028451 A1 describes an interactive and enhanced digital Instant Catalog of products, service, and information that is personalized or personally profiled, to each unique user of the catalog.

### SUMMARY OF INVENTION

It is desirable to provide a method and system for managing the access and royalty collection of digital data, which can be downloaded over a computer network. It is particularly desirable to provide a method and system for managing the access and royalty collection of digital data, that makes use of the viewing of or clicking through advertising for revenue collection or direct revenue collection, and which facilitates the identification and control of “pre-certified”, “certified” or legally licensed for download digital content, thereby providing a mechanism for the distribution of legally downloaded digital content in a commercially viable and efficient manner.

Accordingly, it is an object of this invention to provide a method and system for the management of downloadable digital data, which provides for the collection of royalties.

Another object of an embodiment of this invention is to provide a method and system for the management of downloadable digital data that is compatible with peer-to-peer (P2P) or shared file networks or the like.

It is another object of this invention to provide a method and system for the management of downloadable digital data that is compliant with the Digital Millennium Act of 1998.

It is a further object of this invention to provide a method and system for the management of downloadable digital data that makes use of a digital acknowledgment trigger.

It is a still further object of this invention to provide a method and system for the management of downloadable digital data that tracks the access and sharing of the data.

It is another object of this invention to provide a method and system for the management of downloadable digital data that can provide for royalty payments through the use of downloadable advertisements.

Another object of this invention to provide a method and system for the management of downloadable digital data that tracks file downloads.

A further object of this invention is to provide a method and system for the management of downloadable digital data that provides protection of intellectual property “data” downloads and usage.

A still further object of this invention is to provide a method and system for the management of downloadable digital data that determines the amount of downloads and/or the time a file has been “shared.” It is another object of this invention to provide a method and system for the management of downloadable digital data that facilitates the commercialization of the intellectual properties or downloadable data.

It is a further object of this invention to provide a method and system for the management of downloadable digital data that provides a mechanism for the regulation and tracking of “file-swapping”.

It is a still further object of this invention to provide a method and system for the management of downloadable digital data that provides for the “legalization” of a file received from a “file-swapping” source.

A further object of this invention is to provide a method and system for the management of downloadable digital data that is compatible with standard file sharing, streaming and downloading technologies.

Another object of this invention is to provide a method and system for the management of downloadable digital data that provides an efficient, effective, accurate and functional improvement in the management of downloadable intellectual property.

A still further object of this invention is to provide a method and system for the management of downloadable digital data that is easy to use and provides consumer privacy.

It is an object of this invention to provide a method and system for the management of downloadable digital data that includes an advertisement viewer and a media player.

It is a further object of this invention to provide a method and system for the management of downloadable digital data that, in some embodiments, includes a searchable database of downloadable data.

It is a further object of this invention to provide a method and system for the management of downloadable data that, in some embodiments, targets users of the invention per specific user demographics that are entered into the system by the user.

It is a further object of this invention to provide a method and system for the management of downloadable data, that in some embodiments, targets user of the invention by specific user demographics that are automatically gathered by the system from sources other than direct user input.

It is a still further object of this invention to provide a method and system for the management of downloadable data, that in some embodiments, is able to serve up, via any typical network and/or computing device, advertisements that are demographically targeted to specific users.

It is a still further object of this invention to provide a method and system for the management of downloadable data, that in some embodiments, can lock, encode and/or encrypt data files until after an advertisement or advertisements or some other form of payment occurs.

It is another object of this invention to provide a method and system for the management of downloadable data, that in some embodiments, is compatible with P2P networks, Internet systems, intranet systems, WANs, LANs, cable and wireless systems.

In various embodiments of this invention some, all of the above cited objects or additional objects may be incorporated in the invention. Additional objects, advantages and other novel features of this invention will be set forth in part in the description that follows and in part will become apparent to those skilled in the art upon examination of the following or may be learned with the practice of the invention. Still other objects of the present invention will become readily apparent to those skilled in the art from the following description wherein there is shown and described the present preferred embodiments of the invention, simply by way of illustration of several modes best suited to carry out this invention. The objects and advantages of this invention may be realized and attained by means of the instrumentalities and combinations particularly pointed out in the appended claims. As it will be realized, this invention is capable of other different embodiments, and its several details, and specific components and steps, are capable of modification in various aspects without departing from the concept of this invention. Accordingly, these objects and the following drawings and descriptions should be regarded as illustrative in nature and not as restrictive.

### BRIEF DESCRIPTION OF DRAWINGS

The accompanying drawings incorporated in and forming a part of the specification, illustrate a preferred embodiment of the present invention. Some, although not all, alternative embodiments are described in the following description. In the drawings:

FIG. 1 is a block diagram showing how a User accesses the system of this invention through the Internet.

FIG. 2 is a block diagram showing an overview of peer-to-peer processing.

FIG. 3 is a diagram illustrating a representative user computer system connected to a network.

FIG. 4 is a diagram representing the “agents” that may be stored on the client computer systems to enable those systems to utilize and contribute to the network in accordance with this invention.

FIG. 5 is a flow chart of the process on this current invention.

FIG. 6 is a representative diagram showing how the digital acknowledgement trigger is attached to a user.

FIG. 7 is a diagram showing how a file is transferred to a requesting user.

FIG. 8 is a top-level flow chart of the process of this invention.

FIG. 9 is a flow chart of the process of obtaining a file.

FIG. 10 is a flow chart of the process of exchanging a file in a P2P setting for another user's use.

FIG. 11 is architectural diagram showing the relationship between the components of the present embodiment of the invention.

FIG. 12 is a sequence diagram showing the interactions in the present embodiment of this invention.

Reference will now be made in detail to the present preferred embodiment of the invention, an example of which is illustration in the accompanying drawings.

### DETAILED DESCRIPTION

This invention is a method and system for the management, distribution and royalty collection of digital data files and, as an option, the insertion of targeted advertising. This invention uses downloadable advertisements as a technique for collecting fees for the subsequent download, transfer and/or access of digital data. This invention includes technology for “certifying” and/or authenticating downloaded and/or downloadable files, advertisements and users. This invention also includes technology for targeting and reviewing advertisements, push-marketing of content and/or products.

In its current embodiment, the process of this invention makes use of a user unique digital acknowledgement trigger, which is used to create and define the technique for regulating the current infrastructure of P2P or other file sharing networks, infrastructures, computer systems and/or computer networks overall. Using this invention users share information and content directly, or via centralized computing devices, with the content tracked to manage and in some embodiments may regulate the actual user's file use and royalty payments, as required. The user's digital acknowledgement trigger can permit the user to select his or her choice of audio or video advertisements, the viewing of which can be compensated by the advertiser, thereby providing payment to the content owner as a royalty for access, use, storage or transfer of the user desired digital data file. In the present embodiment, after viewing of the advertisement, the desired file is downloaded to a pre-determined secure area on the user's computer hard disk drive for proper or authorized use. The user's digital acknowledgement trigger is also used to prevent the file from being transferred from the secure area on the user's hard disk drive without first acknowledging that the recipient also has a unique digital also has a unique digital acknowledgement trigger used to receive, track, determine advertisement and download the desired file for “proper use.” The user's digital acknowledgement trigger can include the user's preferences and/or profiles and/or profiles, which are recognized in the present embodiment from an originating server. In the present embodiment, the process of this invention allows a user to select preferred advertisements for viewing.

The process of this invention is presently performed by a self-executing application program that can be updated by an, “individual” user, who can perform an update of the software implementation of the invention. The application program includes the logic for the digital acknowledgement trigger that provides for centralized development, uniformity and integrity of the data files that are stored, shared and accessed by computers, through servers and/or network hardware.

The present embodiment of this invention makes use of peer-to-peer (P2P) networking. Currently, P2P networking is used for the trading and transferring of music, video and other content, each of which may have intellectual property rights and protections, across the Internet. For example, systems such as Napster and KaZaA have been developed specifically to foster the transfer of such content. This invention is, however, not limited to the publication of particular kinds or types of content. This invention is intended to facilitate the “legal” distribution of a wide range of content, embodied in digital data files, across a computer network. The content transferred by this invention can include “live” content, provided by direct feeds as well as prerecorded content. Generally, the publication and retrieval of the content (digital data files of interest) is accomplished anonymously.

As noted above, this invention also addresses the accounting and royalty payment requirements of content owners. By providing a stable, reliable and scalable system and method for the publication, downloading and collection of royalties for the proper or legal use of content files, this invention facilitates compensation to the content owners. Typically, the royalty payment is accumulated from an advertiser who places an advertisement before a user, upon the user's agreement or choice to view such advertisement. In return for the user's agreement or choice to view the advertisement, the advertiser compensates the content owner and the content owner gives permission to the user to browse and/or download available content within the available networked, including Internet connected, computer systems, or otherwise interact with the content network.

For the purposes of this patent disclosure the following terms shall be interpreted to have the following meanings.

Accounting—tracking of data for reporting purposes and/or for entry in an accounting system. Accounting data includes advertisement revenue data and rights payments, calculation and/or digital data access information.

Advertisement—information or data communicatable to users, for which compensation is paid by the distributor of such information or data.

Certified—a file that has been licensed and identified and therefore is marked as certified by this process for users to download. Certified signifies that the file is paying royalties to known content rights holders and that the file will be delivered with known quality and metadata.

Dark Matter—any media (digital data) file that cannot be identified. Identification is performed by comparing fingerprint and metadata of the file to that of known files in the database of this invention.

Digital Acknowledgment Trigger—a device, method and associated data files that track a user's activity with regard to the access, transfer and storage of digital data files. This trigger is located in the process software provided to users in the present implementation of this invention.

Digital Data Files—computer transferable files, including, but not limited to, audio files, video files, text files, graphic files, database files and the combinations thereof.

File Tag—a set of data stored with a media (digital data) file. Typically by way of watermarking, and/or metadata, which can also be looked up in Metadata DB by the Media ID included in the watermark.

Fingerprint—a digital signature-like process and the technology used to build a digital signature of a media (digital data) file based on the media content. For example, for a song, the fingerprint will incorporate the variances in the music that uniquely identifies the song. This process and technology can be used to identify uncertified files.

Identified—the status of a digital data file whose identity has been determined by watermarking, fingerprinting and/or metadata review.

Licensed—content for which intellectual property rights have been contracted from content owners.

Locking—media (digital data) files that are locked upon transfer to a user's computer. Media (digital data) files can be unlocked through a payment action, which initially in this process is typically through the download and “viewing” of an advertisement.

P2P or peer-to-peer—a standard computer to computer file transfer system.

Pre-certified—a file that is uncertified but which is or will be linked to a royalty payment.

Uncertified—a file that is not certified. This status implies that the content owner has not contracted rights for transfer and that there is no guarantee of quality or content.

Unidentified—the status of a digital data file whose identity has not been determined.

Unlicensed—content for which intellectual property rights have not been contracted from content owners.

User Database—a centralized database of information concerning each user's individual trigger, may include a user's access history and preferences and/or profiles.

Viewing—observing, listening, clicking through, purchasing, and/or printing of material.

Watermark—the insertion of data onto or into a digital data file without changing the function-ability or viability of the file. For example, a Media ID and Metadata can be written onto an MP3 or MPEG file without damaging the file's ability to be played.

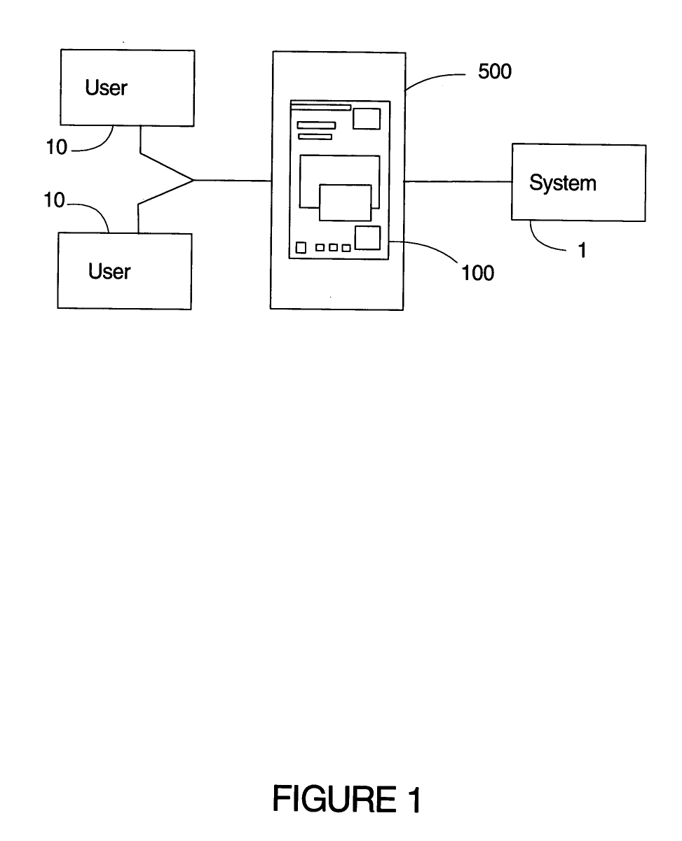

Referring now to the drawings, which describe the present known embodiments of the invention, FIG. 1 shows a block diagram showing how a User accesses the system (currently embodied in a client program) of this invention through the Internet. The system 1 of this invention is shown accessed by users 10 through the World Wide Web 500, through the System Web Site 100. Accessing the System Web Site 100 is typically accomplished through an Internet Service Provider, often referred to as ISPs, or through an on-line service provide such as CompuServe, Prodigy, America Online and the like.

The users 10 presently contact the System Web Site 100 using an informational processing system capable of executing an HTML compliant Web browser such as Microsoft's Internet Explorer, Netscape Navigator, Lynx and/or Mosaic. A typical computer system used by a user with this invention is a personal computer with an operating system such as Windows 95, 98, ME, 2000, Linux, Apple, Unix or the like, running a Web browser program, a stand alone software client or software agent(s). The specific hardware of the user's 10 computer system, the brand of operating system and the brand of Web browser, so long as the user's 10 computer is compatible with a technology for sharing files between computers, need not be a particular configuration in order to understand or practice this invention. As is well understood by those of ordinary skill in the art, standard computer hardware, operating system, Peer-to-Peer (P2P) and client server networks, and computer architectures and Web browsers, configured to permit computer-to-computer communication can be used to implement the method and can be used as part of the system of this invention, which is defined by the scope of the claims.

In a traditional client-server distributed computer system, application software functions are typically split between server tasks and client tasks. A client system typically transmits a request to the server and the server responds accordingly. An agent is the part of the system that prepares or exchanges information on behalf of a server or a client. In a peer-to-peer system, some agents can perform both server and client roles.

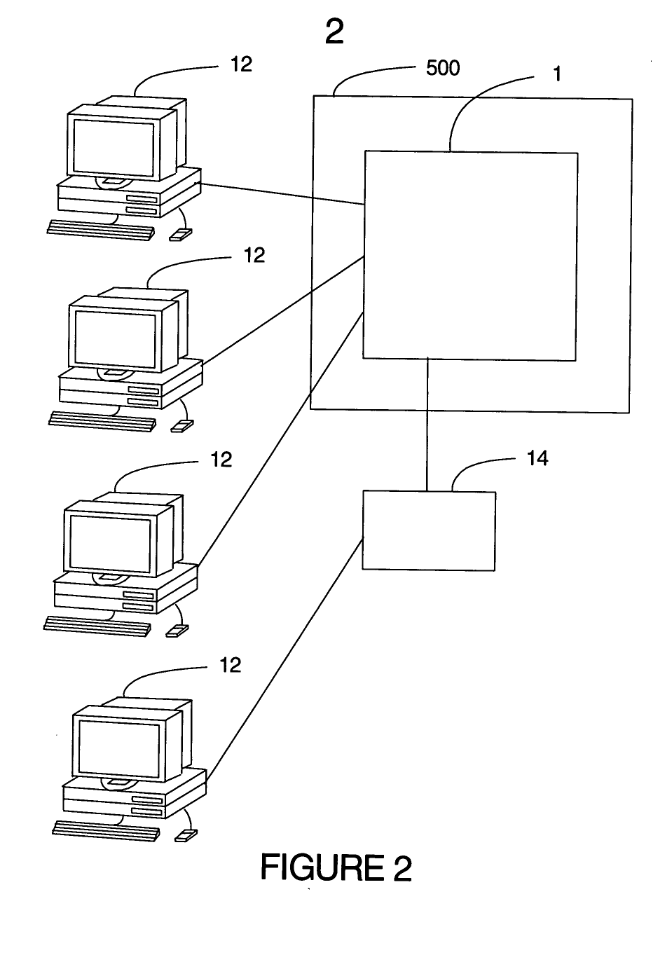

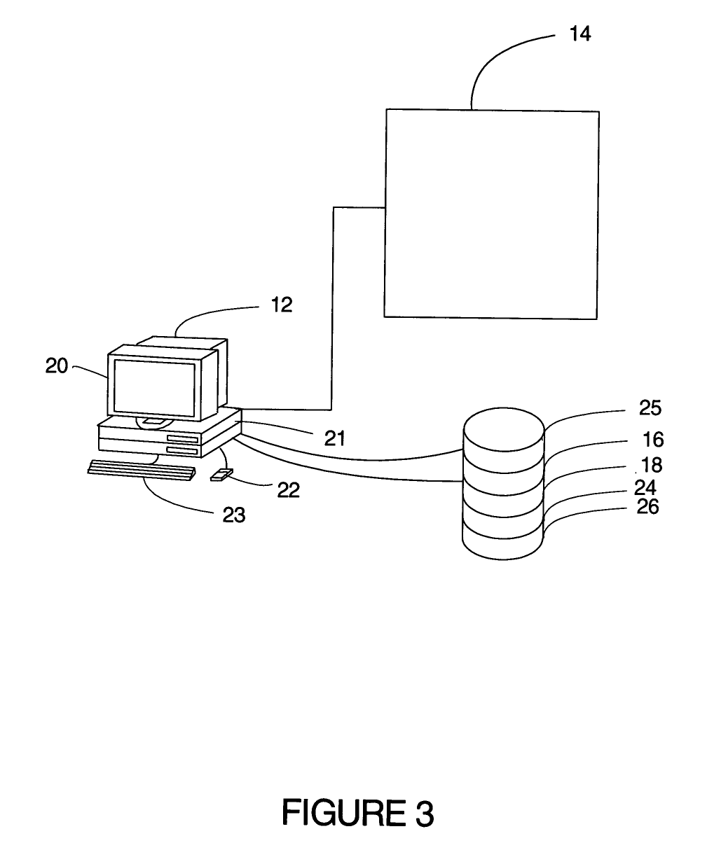

FIG. 2 is a block diagram showing an overview of peer-to-peer processing, in accordance with the concept of this invention. The system 1 may include one or more client computers 12 connected in a peer-to-peer fashion across a Wide Area Network (WAN) 14, such as the Internet, or more particularly the World Wide Web. The user's 10 computer may contain one or more pieces of software code 16 (agents) that may be stored on these machines and may be executed by a respective microprocessor 18 (see FIG. 3) in order to operate as the invention. The Internet 500 permits the client computers 12, when accessed by other computers 12 in the network 14, to communicate with each other, in order to serve or host various requests or operations and to otherwise interact with each other.

FIG. 3 shows a diagram illustrating a representative user computer system 12 connected to a network 14 as shown in FIG. 2. A representative user computer system 12, as shown, includes a display device 20, a chassis 21 and one or more user input devices, such as a mouse 22 and a keyboard 23. The chassis 21 typically contains a storage system 24, such as a hard disk drive, optical disk drive, tape drive or the like, which stores one or more software application programs, such as a Web browser 25 and one or more agents 16. The client computer system 12 chassis 21 also includes memory, such as RAM and ROM and the like, used by the CPU 18 to execute the application programs and other software, stored in the storage system 24. The Web browser or P2P application, software client or software agent(s) 25 is typically configured to connect the client computer system 12 with other computers 12 in the network 14 and receive textual and/or graphical information (i.e., Web pages) that may be displayed on the display device 20 to a user. The browser or P2P application program, software client or software agent(s) 25 also presently permits the client computer systems 12 to interact with other computers 12 in order to serve or receive or host requests and operations in accordance with the invention.

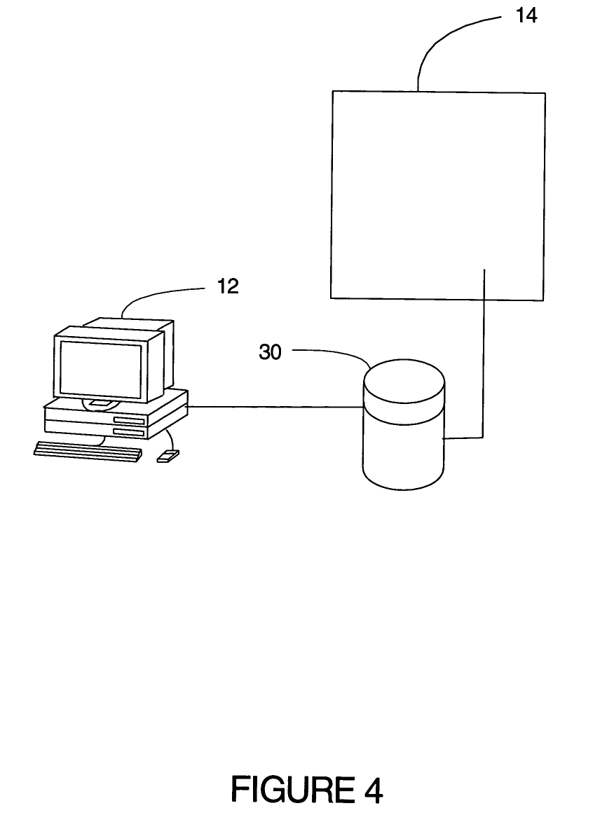

FIG. 4 is a diagram representing the “agents” and other software components 16 that may be stored on the client computer systems 12 to enable those systems to utilize and contribute to the network 14 in accordance with this invention. The client computer systems 12 may, in some embodiments, include a first software module 30 (i.e., a client agent) that is operable to enable these client computers 12 to access the network 14 and to be capable of using computer system resources provided by other computer systems 12 connected to the network 14. A user 10 may download and install a client agent 30, across the Internet using standard well-known download techniques, or may, in the alternative, purchase or otherwise obtain the client agent software 30 and directly install it 30 onto the computer system 12. Alternatively, the client agent software 30 may be provided preinstalled on the computer system 12.

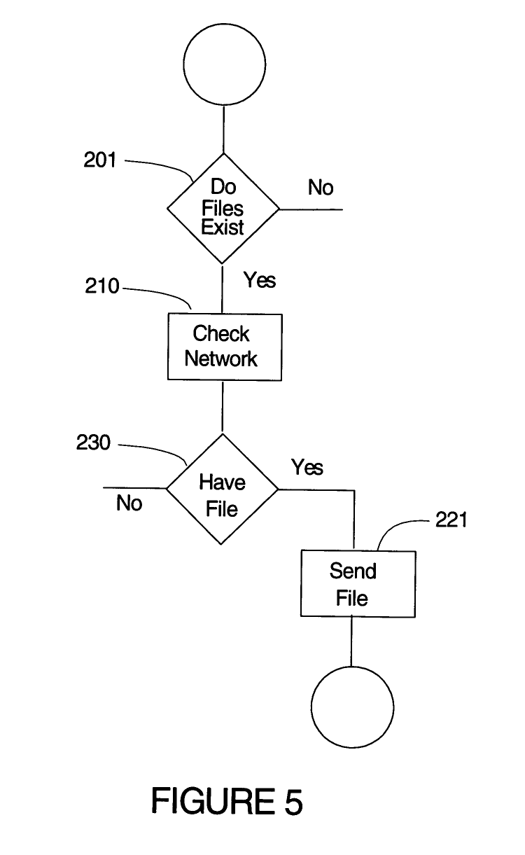

FIG. 5 shows a flow chart of the process on this current invention. In this present embodiment, user of a P2P audio and/or video network, uses the software for an end user to practice the method of this invention, particularly the digital acknowledgement trigger. The user's computer (“user”) inquires 210 of a computer network or similar computer server if a specific desired audio art file exists on the particular computer or network related computer or server. Computers and/or network servers or devices which are “hooked” up or in communication with the user's computer check 210 for the desired file and respond with a Yes or a No. If the responding computer and/or network server or device responds with a Yes, it then checks 230 if it has the file for download. If the responding computer and/or network server or device has the file available for download, it is sent 221 to the user's computer. Typically, the file is locked or encrypted until a payment action is confirmed.

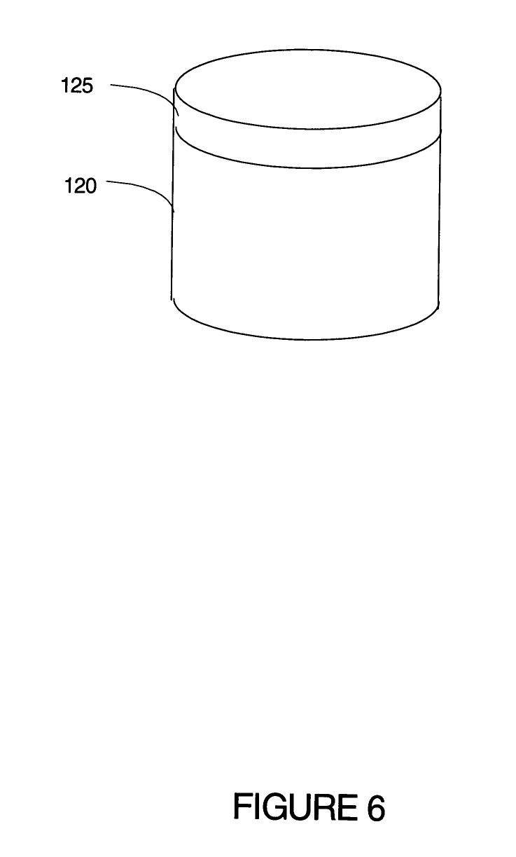

Each user using the present embodiment of the invention has a unique Digital Acknowledgement Trigger 125, which is an individual process or data set stored on the user's computer system hard disk (shown in FIG. 6). This trigger 125 is activated by the user on the user's computer or network related computer or server mentioned with respect to step 210. Each trigger 125 is uniquely based on the source Internet Protocol (IP) address of each user and/or, in some embodiments, other user specific information. The file name requested for download by the user is presently recognized by its Watermark and/or with each user's digital acknowledgement trigger 125 when initiated. In this embodiment, the user's digital acknowledgement trigger 125 is activated when the digital data file is requested by the user. In the present embodiment of the invention, the activation of the user's digital acknowledgement trigger 125 does not damage or interfere with the original file intended for use. When the digital data file is requested, the data rights management aspects of this invention ensures that the owner, if any, of the requested file can be paid a “royalty” for the “proper use” of the file. For example, some “proper uses” may be one-time only uses. Others may be for one user's use only. While other “proper uses” may include the capability of using and transferring a data file. Also, in some “proper uses”, a digital rights management program embedded in the file may cause the file to expire or delete itself after a specified number of uses. The “royalties” paid to the owners of the requested data file, can vary from file to file and from “proper use” to “proper use” with some files and some uses costing more or less than others. Typically, the royalties are paid by advertisers for the download and viewing of advertisements to the user. The royalties are generally paid electronically over a computer network, using standard secure electronic commerce techniques. Alternatively, the user can pay directly for the right to download a file and thereby avoid viewing an advertisement.

FIG. 6 is a representative diagram showing how the digital acknowledgement trigger 125 is attached to a user's or a centralized storage device, computing device and/or computer software. The digital acknowledgement trigger 125 can be activated before the requested file 120 is downloaded to the user's storage device. The present embodiment of the digital acknowledgement trigger 125 includes an “activity reporting process” that is unique for each user and for each file 120 being downloaded. As noted above, some files may have higher royalty rates than others, as pre-determined by the owner(s) of the particular file.

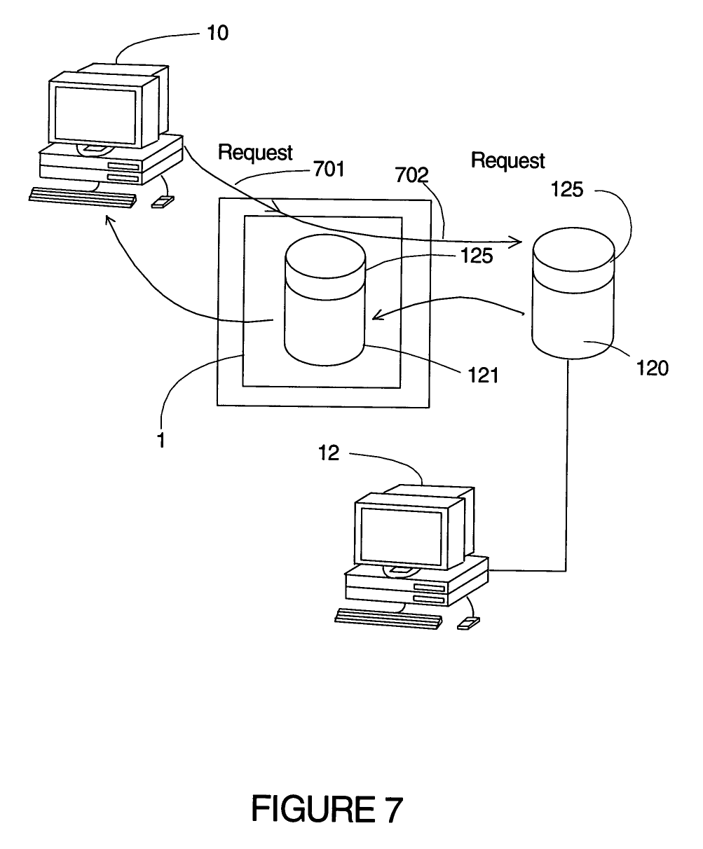

FIG. 7 is a diagram showing one present embodiment of the process of how a file is transferred to a requesting user. The user at the user's computer 10 makes a request 701 to the system 1 for a requested file 120. The system 1 then makes a request 702 to other clients 12. If one, or more, of the other clients 12 have the requested file 120, the file 120 is uploaded 121 to the system 1. The user's digital acknowledgement trigger 125 acknowledges the “request” 701 that the user has made to download the file 120. The file 121 is then downloaded from the system 1, or other client users, to the user 10 and the digital acknowledgement trigger 125 acknowledges the user's preferences and/or profiles for advertisements and allows the user 10 to select their requested advertisement. The selected advertisement is transferred to the user 10, who views the advertisement. When the trigger 125 confirms that the user has viewed the advertisement, the trigger 125 registers a royalty to an accounting computer system. The trigger 125 then allows the selected file 121 to be downloaded (or uploaded) to (or from) the user's system 10. In an upload situation, the file 121 is uploaded from the user's system 10 to a secure area on a server computer, or more typically directly to another P2P client user. Alternatively, user's may request to other P2P clients directly. Also, alternatively, users on the system can request files from the entire system and then can receive them from a central server.

In operation, a corporation and/or other businesses enterprise embodiment of the licensed software incorporating the method of this invention, which includes the logic that includes the digital acknowledgement trigger 125. The business embodiment of the digital trigger of this invention provides the protected process that ensures that a businesses P2P or “file sharing” business, or portal or ISP or wireless or broadband provider or other similar business entity, can enter “commercial” status legally, while keeping all parties that have a vested ownership interest in a particular digital data file satisfied. Corporations and other businesses use the software of the business embodiment of this invention to provide their users with unique digital acknowledgement triggers 125 in order to track “to be downloaded or shared” files that are shared within a particular firms business to consumer communities that are “open” for access and download of desired digital data files.

When the user/computer 10 download of the desired digital data file is complete, the digital data file is now located on the computer or network related computer device or server where the downloaded data was delivered. The user then opens or uses the digital data file associated with the digital acknowledgement trigger 125, thereby initiating the process of this invention. When the user/computer 10 opens the file 120, the digital acknowledgement trigger 125 of this embodiment of the invention can provide the owner, or other selected entity, of the digital data file 120 the following information, including but not limited to: the identification of the user/computer 10 where the digital data file is opened, the date, how often the file has been transferred, exchanged, emailed and whether others have downloaded the file from the user's secure storage area, for which the digital acknowledgement trigger is associated. This embodiment of the invention then can send and/or route information and/or payments directly to the appropriate parties in the P2P or file sharing networking environment. The appropriate parties are typically, although not exclusively, the intellectual property rights owner, the licensee who licenses the intellectual property, the network managers, the Internet service providers or presence providers that host or provide for the actual originating file download that is shared by end users of that particular file or provides users 10 for these exchanges. The software process sends a software trigger (or the “digital acknowledgement trigger 125) to an originating platform. The user is provided the opportunity to select an advertisement. The requested files are generally not available to the user before the user selects and view the advertisement. The advertiser of the selected advertisement provides some or all of the payment required for the royalty for access to the desired digital data file. After the user's preferences and/or profiles are acknowledged, the software trigger 125 in the present embodiment of the invention provides the capability for the advertisement to be assigned before “delivery or download” based on the user's “preferences and/or profiles.” The assigned advertisement is opened before the file used by the user/computer 10 and used for its purpose. Prior to the opening of the assigned advertisement, the end user 10, if not already a registered user, downloads and installs the software digital acknowledgment trigger 125, in order for the user 10 to “pay” for the “proper use” of the digital data file. After the user 10 has “paid” for the access to the digital data file by viewing the selected advertisement, the digital acknowledgement trigger 125 activates the digital data file and accounts for the payment of the predetermined royalty. In this embodiment, the process operates with any downloaded or shared Internet based, network based and/or computer based multi-media files or other similar content. The digital acknowledgement trigger 125 then provides a report of royalty payment information to the originating licensee or owner of the digital data file.

This embodiment of the invention provides the capability of intellectual property owners and other parties of “interest” in a particular digital data file to approach advertisers and other parties for commercialization of the P2P networking or file sharing of the owner's digital data files. The digital acknowledgement trigger is flexible in allowing an advertisement to be viewed one or more than one time and, in some embodiments, to permit the advertisement to be changed or replaced as a scheduled event. The digital acknowledgement trigger 125 can reactivate itself when another user downloads and/or requests another file. In the present embodiment, the user 10 is also provided the capability to choose which advertisement or types of advertisements that they prefer to view by establishing the user's 10 preferences and/or profiles. The digital acknowledgement trigger is designed to recognize and accommodate user's 10 preferences and/or profiles. This embodiment of the invention allows digital data file owners or other entities that share files to establish a unique digital acknowledgement trigger 125, to play or send out a message to end users and to integrate and/or remove advertisements based on current events or an established schedule.

The present embodiment of the invention further provides that commercial programming (“advertising”) after specified period of time can be reset or changed to produce alternative advertisements. In addition, in an embodiment of this invention, an install/remove advertisement function is provided to automate and/or facilitate the manual changing of the advertisements. The present preferred method of this invention also includes functions for reporting information that includes royalties for advertising fees, the number of downloads, the number of actual opening of the digital data files, the usage of a digital data file during its entire “life span.” A user 10 can also use the capability of this invention to send a digital data file to another entity, computer, computer network, or person. In this use the digital acknowledgement trigger 125 will re-activate itself when the digital data file is requested.

In sum, the digital acknowledgement trigger 125 of this invention provides the mechanism for computers and programs to work together to manage, track and regulate the process of file sharing of digital data files between two or more computer systems over computer networks and account for royalty payments for the rights owners of the digital data files. This invention, including the digital acknowledgement trigger 125, provides a solution to legal disputes over the “unregulated” process of computer file sharing or P2P of digital data files. Royalty payments are collected in a manner likely to be acceptable to users. A new channel for controlled distribution of advertising is also provided. Market data is collected. Moreover, the process of this invention helps protect companies that own and/or distribute P2P networked data to the commercial and consumer markets worldwide. This invention also provides the capability for all parties that have owned or licensed interest in the particular “file shared” to track end user downloads for the determination of royalty payments and business development. Parties that have an interest in the “shared file” include, but are not limited to: (a) the originating server where the digital data file was stored by the owner; (b) the person, network, computer device, server requesting the digital data file; (c) the person, network, computer device, server opening the digital data file; and (d) the person, network, computer device or server that shares the digital data file. The invention provides for the continuation of so-called “free downloads” and the legal use of digital data file content by consumers. The present embodiment of this invention also provides the capability for the control of the distribution of files between computers, servers, network servers, and other networkable or wired or wireless devices. This invention is compatible with existing P2P and “file sharing” networks.

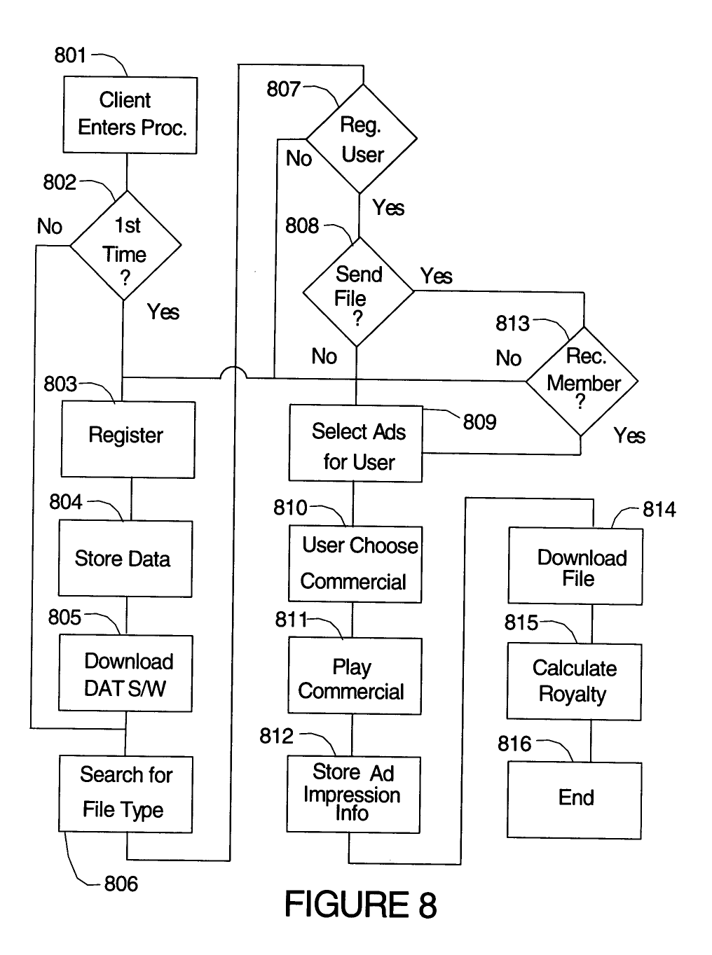

FIG. 8 shows a top-level flow chart of the process, including that of the digital acknowledgement trigger, of this invention. The client or user enters 801 the process for the downloading of one or more digital data files. A test 802 is made to determine if this is the first time the user has entered the process. If it is not the user's first time using this process, the user is permitted to search 806 for the desired file type. If it is the first time the user entered the process, the user is registered 803 submitting basic information about his or herself and his or her interests. This information is stored 804 in a centralized user database and typically is also stored in the client software. The registration 803 process is designed to gather information on the user interests, hobbies, preferences and/or profiles, lifestyle and the like that can be used to deliver advertisements of high interest to the user. The user downloads 805 and installs the digital acknowledgement trigger on his or her computer. The digital acknowledgement trigger is used to substantially control the remaining process of the invention. The user then searches 806 for the desired file. Files include, but are not limited to, music files, video files, graphics files, data files and/or text files. Once a desired file is found in the search 806, a test 807 is made to determine if the user is a registered user. If the user is a registered user, a test 808 is made to determine if the user wishes to send a file. If the user is not a registered user, the user is registered 803. If the user does not wish to send a file, the digital acknowledgement trigger selects 809 one or more (typically three) advertisements based on the user's profile/preference information for the user to select from. The user chooses 810 the advertisement for viewing. The advertisement is played 811 on the user's computer system and advertisement impression information is collected and stored 812. In the present embodiment, after the user selects 810 and views 811 the advertisement, the desired digital data file is downloaded 814, and digital data files are locked or encrypted until after the user views 812 the advertisement or group of advertisements. These advertisements or groups of advertisements are required to be viewed by the user in lieu of cash or credit payments for access to the digital file. A royalty for the download 814 is calculated 815 and the process ends 816. If the user wishes to send 808 a file, a test 813 is made to determine if the intended recipient is a registered user. If not, the recipient is registered 803 as described above. If the recipient is a registered user, a selection of advertisements is made 809 based on the recipients profile and/or preference information, which typically includes digital file content and/or advertising preferences. In some embodiments of this invention, while the user is viewing either the advertisement or the downloaded digital data file, the user may be provided with a short cut, hyper-link or coupon to facilitate the purchase of the advertised or downloaded material in a fixed format. In the present embodiment of the invention, such coupon can be used by the user at that time or later.

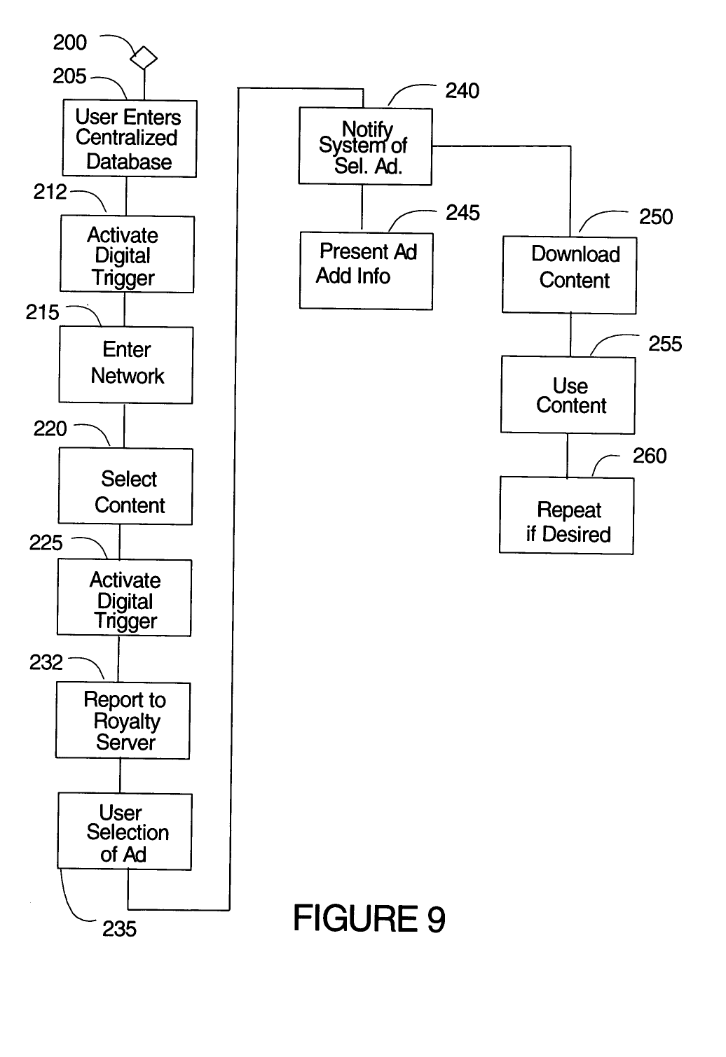

FIG. 9 shows a flow chart of the process a user 10 uses to obtaining a digital data file using the digital acknowledgement trigger of this invention. User A 200 starts by entering 205 a centralized database of the system 1. The system 1 activates 212 a digital acknowledgement trigger for user A 200. User A 200 enters 215 the network that contains the desired digital data file content. User A 200 then selects 220 the content. The digital acknowledgement trigger is activated 225. User A's digital acknowledgement trigger 125 reports 232 to the royalty server for accounting for potential advertisement or royalties associated with the content of the digital data file. User A 200 makes a selection 235 of the desired advertisement if there is a chose provided. The system 1 is then notified 240 of the advertisement that user A 200 has chosen to view. After or during the viewing by user A 200 of the advertisement, the system 1 of this invention may add a digital coupon, hot button or hyper link to the advertiser's website 245. The desired digital data file content is downloaded 250 by user A 200. User A 200 then can use 255 the content and if additional content (digital data files) is desired, user A 200 can repeat 260 the process as necessary.

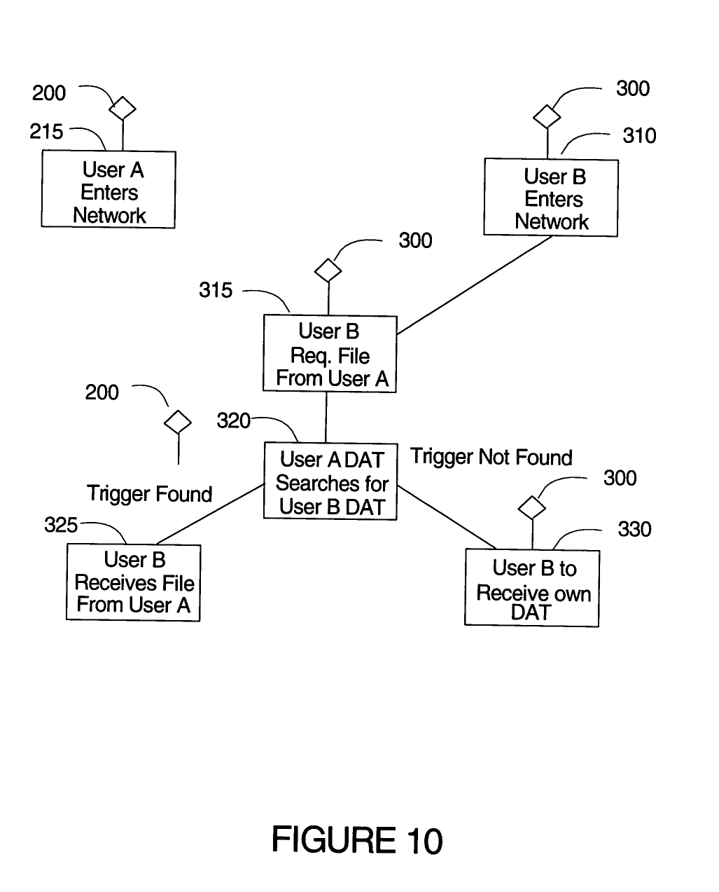

FIG. 10 shows a flow chart of the process of exchanging a file in a P2P setting for another user's use, using the digital acknowledgement trigger 125 of this invention. User A 200 enters 215 the network of this invention looking for desired digital data file content. User B 300 enters 310 the network to look for desired digital data file content. User B 300 requests 315 the desired digital data file content from user A's 200 computer. User A's 200 unique digital acknowledgement trigger 125 searches 320 user B's 300 computer for user B's 300 unique digital acknowledgement trigger. If user B's 300 trigger is found, the procedure described in FIG. 7 is followed by user B 300 to receive the file 325. If user B's 300 trigger is not found, then user B 300 is sent to a website 100 in which user B 300 can register and receive 330 his or her own digital acknowledgement trigger 125.

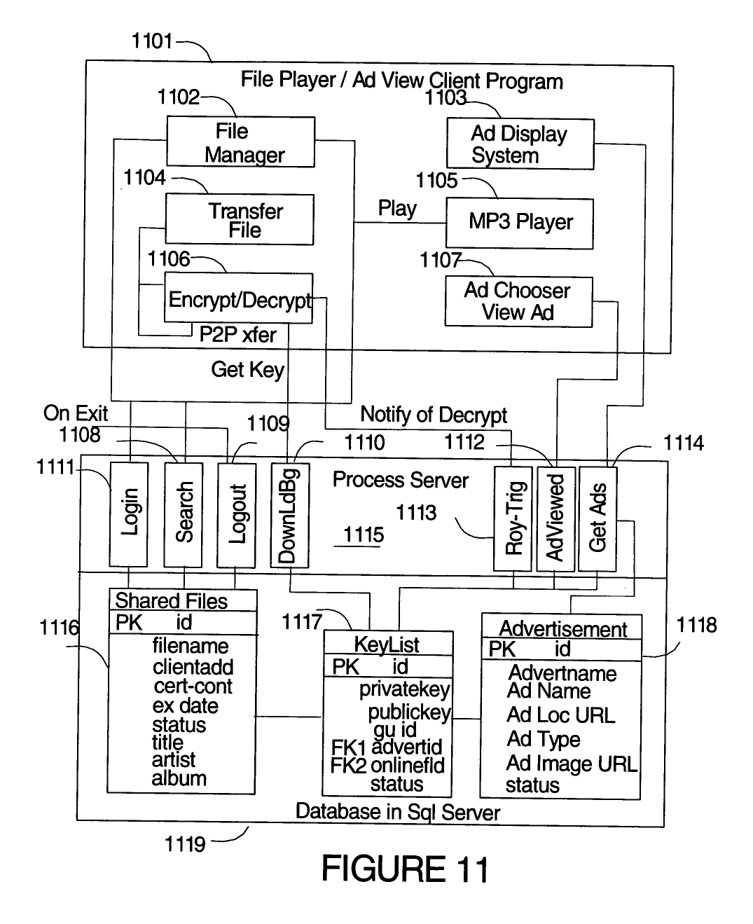

FIG. 11 is architectural diagram showing the relationship between the components of the present embodiment of the invention. A file player/advertisement viewer 1101 interacts with a process server 1115, which in turn communicates with a database server 1119. The file player/advertisement viewer 1101 includes a file manager 1102, a transfer file function 1104, an encrypter/decrypter 1106, an advertisement display system 1103; an MP3 player 1105 and an advertisement chooser/advertiser viewer 1107. These functions pass data to each other and to the process server as shown. The process server 1115 includes a login process 1111, a search process 1108, a logout process 1109, a download begin process 1110, a royalty trigger process 1113, an advertisement viewer 1112 and a get advertisement process 1114. The process server 1115 provides the public interfaces via Web Services to the data base architecture of 1119. In its 1115 present embodiment the process server 1115 implements XML and DOM transactions in the service modules and presently uses .Net Crypto libraries to generate Public/Private Key combinations for return to the user (client). The login process 1111 uses shared files to define the upload package for login, with all shared files listed. The search process 1108 presently uses a passed parameter to search for matching files by artist, album or title. The download begin process 1110 once requested provides the user (client) with a public key for the encryption of the file data by passing the requested file information to the server 1115. The get advertisements 1114 process is a request for a list of advertisements to choose from. The advertisement viewed process 1112 provides the user with a choice of advertisements to view; the present request of this type is an HTML based request to a server location. The royalty trigger process 1113 is the message used to confirm the music file has been decrypted and a royalty-generating event has occurred. These processes pass data and information to the functions of the file player/advertisement viewer 1101 and the database server 1119 as shown. The database server 1119 includes shared files records 1116, key list records 1117 and advertisement records 1118. Additional processes may include: a registration process for single or multiple users, a user profile/preferences process; a user profile/preferences edit process; an advertisement selection process; and processes for advertisers to offer sales offers and push marketing.

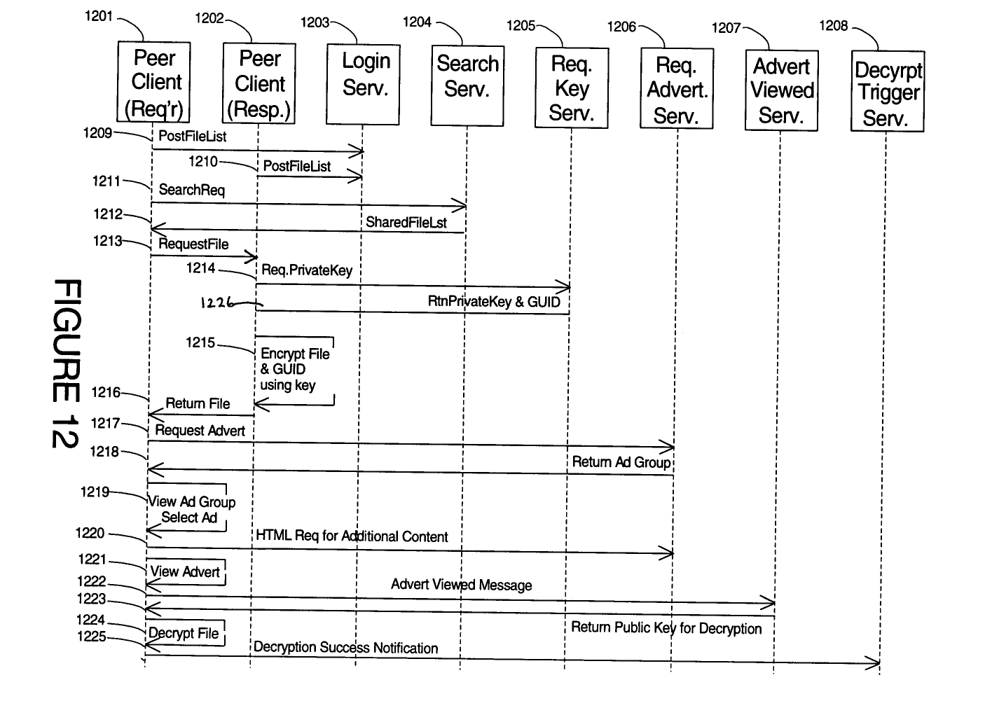

FIG. 12 is a sequence diagram showing the interactions in the present embodiment of this invention. Each step in this figure has a respective Web service and client action to trigger the shown interaction between the client and server. The Peer Client (Requester) 1201 posts a file list 1209 to the Login Server 1203. The Peer Client (Responder) 1202 posts a file list 1210 to the Login Server 1203. The Peer Client (Requester) 1201 submits a search request 1211 to the Search Server 1204. The Search Server 1204 responds with the shared file list 1212. The Peer Client (Requester) 1201 requests a file 1213. The Peer Client (Responder) 1202 requests a private key 1214 from the Request Key Server 1205. The Request Key Server 1205 responds with a private key and GUID 1226. The Peer Client (Responder) 1202 encrypts 1215 the requested file and GUID using the private key. The requested file is returned 1216 to the Peer Client (Requester) 1201. The Peer Client (Requester) 1201 requests 1217 an advertisement. The Request Advertisement Server 1206 returns 1217 a group of advertisements. The Peer Client (Requester) 1201 views the advertisement group and selects 1219 an advertisement. The Peer Client (Requester) 1201 submits 1220 an HTML request for additional content. The Peer Client (Requester) 1201 views 1221 the selected advertisement. An advertisement viewed message 1222 is sent to the Advertisement Viewed Server 1207, which returns 1223 a public key for decryption. The Peer Client (Requester) 1201 uses the public key to decrypt 1224 the requested file and send 1225 a decryption success notification to the Decrypt Trigger Server 1208.

Alternative embodiments, in emerging applications for this invention include wireless communication, wireless Internet, interactive television, satellite dish communications, television, personal recording devices and the like. Network platforms developed for the P2P or file-sharing network oriented communities are also applicable for the use of this invention. The current embodiment of the invention works with file opener programs, browsers, media players, presently available, including but not necessarily limited to such file sharing technologies as (a) audio multi-media file sharing (including MP3, wavdigital art and the like); (b) video multi-media file sharing; (c) digital audio file sharing; (d) digital video file sharing; (e) wireless file streaming, sharing and transferring; (f) digital art, protected arts; and (g) gaming art sharing.

Entities that regulate, originate, operate or own P2P or file-sharing network infrastructure, ISP and portals, and which permit others to have access to files on their servers or web portals, via the Internet will find this invention to have substantial utility in the management of digital data files. Individuals, including the public and information and media consumers, will find this invention to be very effective and beneficial to facilitate the access to “free” legal digital content. Registered end users and/or consumers can download and/or play desired digital data files, which originate from the supplying entities. These entities are provided with the capability of monitoring downloads, sales, promotions, file usage, statistics, trends, demographics and the like. A user specific digital acknowledgement trigger is provided, stored and established on the user's computer long-term storage device. Data provider entities may have their own specific digital acknowledgement triggers. When a user downloads a desired digital data file to the user's computer, information is accumulated regarding the user's interests and preferences and/or profiles. In some embodiments of this invention, the provider entities can use this collected information to distribute information expected to be of interest to the users. Advertising, which pays for the royalties associated with the digital data file, are selected according to the user's interests and profiles. The users themselves are typically provided the opportunity to select the advertisement of greatest interest. The digital acknowledgement trigger function determines which advertisers, if any, have partnered with specific digital data files or content, which have been requested by a user. The software client, and/or browser, user's client or user's audio (MP3) or video player or file reader assembles the desired digital date file and the advertisement generally together. Once the advertisement is viewed, the digital acknowledgement trigger permits the digital data file to be accessed and used by the user. This process is capable of handling the transfer of desired digital data files from one user to another, as previously described, during which process the digital acknowledgement triggers of both users are accessed and activated, or alternatively from a central database to another database. Advertisers and digital data file content owners can determine if advertisements are played once, played always, or played a specified number of times by a user. The digital acknowledgement trigger can be rendered inactive after the digital data file is downloaded to the user's long-term storage device. The downloaded digital data file may be stored in a secured, where the digital acknowledgement trigger must be used to access, or in an unsecured area of the user's computer according to data rights owner requirements and specifications. Revenue from advertising is provided to pay the owner royalties for the download of the digital data file to the user, at which point the downloaded data is a “certified” copy of the file. Alternatively, as previously noted, a user may elect to pay the data rights owner royalties directly, thereby avoiding the need for the user to view selected advertisements. The present embodiment of this invention also provides the capability of the digital acknowledgement trigger to automatically acknowledge when an advertiser or file content owner changes or should be removed (expires). In the present embodiment, the advertiser/owner reset management is an automatic or predetermined result of the process.

The present embodiment of this invention also provides for the update of advertising and for a wide variety of content licenses, including but not limited to a blanket license, a per downloaded file license, a specific use license. This invention is compatible with the intentions of content copyright owners and associations of owners such as ASCAP, BMI, and Sound Exchange and the like. This invention addresses the problems of Internet music and other digital file copyright infringements; provides controls for the access materials (for example child protections); the timed release of materials according to geographic or national boundaries; allows for multi-lingual platforms; controlled distribution of MP3 recordings and other digital files; collects user data file, data file owner, advertiser and advertisement statistics and data; tracks royalties and payments; facilitates the “free” distribution of music and other content; and promotes the legal file sharing and P2P file transfers.

The present, previously described versions of the present invention have many advantages some of which are identified herein. The present invention is a system and method for Internet based or peer-to-peer (P2P) file transfers, or client-server file transfers that are secure, quick, profitable, user friendly and legal. The intent of this invention is to provide an improved method and system for searching the Internet and other repositories of digital data files for specific information. The digital acknowledgement trigger device and process solves a number of problems that previously existed with P2P file-sharing and/or other digital content distribution networks, including but not limited to entities that are unable to track and pay royalties for the “proper use” of content/file downloads; entities that are unable to protect the download of content associated with intellectual property rights; entities that are unable to determine the number of downloads and/or the times that the files has been “shared” and paid for; entities that are unable to commercialize and profit from the distribution of digital content over computer networks, like P2P, which encourages and allows for file sharing but which does not provide for the collection of royalties for “proper use”.

Therefore, although the present invention has been described in considerable detail, with reference to certain present preferred embodiments, it is to be understood that the above described and referenced embodiments and examples are merely illustrative of numerous and varied other embodiments and applications which may constitute applications of the principles of the invention. These example embodiments are not intended to be exhaustive or to limit the invention to the precise form, connection or choice of objects, platforms, computer language or modules disclosed herein as the present preferred embodiments. Obvious modifications or variations are possible and foreseeable in light of the above teachings. These embodiments of the invention were chosen and described to provide a best illustration of the principles of the invention and its practical application to thereby enable one of ordinary skill in the art to make and use the invention, without undue experimentation. Other embodiments may be readily devised by those skilled in the art without departing from the spirit or scope of this invention and it is our intent that they be deemed to be within the scope of this invention, as determined by the appended claims when they are interpreted in accordance with the breadth to which they are fairly, legally and equitably entitled.

1. A method for the management of the distribution of digital data files, comprising:
(A) receiving a user;
(B) registering said user;
(C) downloading a digital acknowledgement trigger;
(D) searching for a digital data file;
(E) selecting one or more advertisements for choice of viewing by said user;
(F) choosing an advertisement from said selected one or more advertisements;
(G) viewing said chosen advertisement;
(H) downloading said digital data file; and
(I) accessing said downloaded digital data file.

2. A method for the management of the distribution of digital data files, as recited in claim 1, further comprising identifying said user demographically.

3. A method for the management of the distribution of digital data files, as recited in claim 1, further comprising assigning a unique digital acknowledgement trigger to said user.

4. A method for the management of the distribution of digital data files, as recited in claim 1, further comprising providing one or more advertisements to said user.

5. A method for the management of the distribution of digital data files, as recited in claim 1, further comprising storing data related to the preferences and/or profiles of the user.

6. A method for the management of the distribution of digital data files, as recited in claim 1, further comprising calculating a royalty based on said downloaded file and said viewed advertisement.

7. A method for the management of the distribution of digital data files, as recited in claim 5, wherein said selection of advertisements is based on said stored data related to the preferences and/or profiles of the user.

8. A method for the management of the distribution of digital data files, as recited in claim 1, wherein said digital acknowledgement trigger further comprises a unique trigger associated with the user and said user's preferences and/or profiles.

9. A system for the management of the distribution of digital data files, comprising:
(A) a user computer system;
(B) a server computer system;
(C) a network connecting said user computer system with said server computer system;
(D) a digital acknowledgement trigger a portion of which can be installed on said user computer system;
(E) a database stored on a storage device in communication with said server computer; and
(F) a collection of digital data files stored on a storage device in communication with said network.

10. A system for the management of the distribution of digital data files, as recited in claim 9, wherein said network further comprises a network selected from the group consisting of the Internet, a wide area network, a wireless network, a telephone network, a broadband network, a cable network, a satellite network, a local area network and a digital distribution network.

11. A system for the management of the distribution of digital data files, as recited in claim 9, wherein said collection of digital data files further comprises a file selected from the group consisting of audio files, video files, graphics files, text files, software files, game files and multi-media files.

12. A system for the management of the distribution of digital data files, as recited in claim 9, wherein said digital acknowledgement trigger further comprises a mechanism for selecting advertisements; a mechanism for viewing advertisements and a mechanism for generating royalties from said viewed advertisements.

13. A system for the management of the distribution of digital data files, as recited in claim 9, further comprising a means for downloading desired digital data files.

14. A system for the management of the distribution of digital data files, as recited in claim 9, further comprising a means for paying royalties to owners of said digital data content files.

15. A method for the management of the distribution of digital data files, as recited in claim 1, further comprising creating a digital trigger.

16. A method for the management of the distribution of digital data files, as recited in claim 1, further comprising modifying a digital trigger.

17. A method for the management of the distribution of digital data files, as recited in claim 1, further comprising storing data related to the profile of the user.

18. A method for the management of the distribution of digital data files, as recited in claim 4, wherein said selection of advertisements to be provided to said user is based on said stored data related to the profile of the user.

19. A method for the management of the distribution of digital data files, as recited in claim 1, wherein said selection of advertisements to be provided to said user is based on said stored data related to advertisement information.

20. A method for the management of the distribution of digital data files, as recited in claim 1, wherein said selection of advertisements is based on a context of said digital data file.

21. A method for the management of the distribution of digital data files, as recited in claim 1, wherein said selection of advertisements is based on said stored data that is related to said user's profile, the profile of said digital data file being downloaded, profiles and preferences of the of a rights holder of said digital data file.

22. A method for the management of the distribution of digital data files, as recited in claim 1, wherein said digital data file is made inaccessible by said user until said user views one or more advertisements.

23. A method for the management of the distribution of digital data files, as recited in claim 22, wherein said digital data file is made inaccessible by locking said digital data file.

24. A method for the management of the distribution of digital data files, as recited in claim 22, wherein said digital data file is made inaccessible by encrypting said digital data file.

25. A system for the management of the distribution of digital data files, as recited in claim 9, wherein said user computer system is a wireless communication device.

26. A system for the management of the distribution of digital data files, as recited in claim 9, wherein said user computer system is a personal data assistant.

27. A system for the management of the distribution of digital data files, as recited in claim 9, wherein said user computer system is an MP3 player.
